(19) United States
(12) Patent Application Publication
(10) Pub. No.: US 2021/0382933 A1
(43) Pub. Date: Dec. 9, 2021

(54) METHOD AND DEVICE FOR ARCHIVE APPLICATION, AND STORAGE MEDIUM

(71) Applicant: SHENZHEN SENSETIME TECHNOLOGY CO., LTD., Shenzhen (CN)

(72) Inventors: Weilin LI, Shenzhen (CN); Dong Liang, Shenzhen (CN); Jiabin Li, Shenzhen (CN); Guiming Zhang, Shenzhen (CN); Jiangtao Li, Shenzhen (CN)

(21) Appl. No.: 17/407,227

(22) Filed: Aug. 20, 2021

Related U.S. Application Data
(63) Continuation of application No. PCT/CN2020/093401, filed on May 29, 2020.

(30) Foreign Application Priority Data
Jun. 28, 2019 (CN) 201910573477.1

(51) Int. Cl. G06F 16/53; G06F 16/58

(52) U.S. Cl. CPC G06F 16/53; G06F 16/5866

(57) ABSTRACT

Disclosed are a method and device for archive application, and a storage medium. The method for archive application includes: acquiring target time and space range information; determining, based on the target time and space range information, at least one target clustered archive in a clustered archive library, wherein the at least one target clustered archive matches the target time and space range information, each of the at least one target clustered archive includes archive information of a respective acquisition object, and the archive information includes activity time and space range information of the respective acquisition object; and performing a predetermined operation based on the at least one target clustered archive.

### CROSS-REFERENCE TO RELATED APPLICATIONS

This application is a continuation of International Application No. PCT/CN2020/093401, filed on May 29, 2020, which is based on and claims priority to Chinese Application No. 201910573477.1, filed on Jun. 28, 2019. The contents of International Application No. PCT/CN2020/093401 and Chinese Application No. 201910573477.1 are incorporated herein by reference in their entireties.

### BACKGROUND

In the field of intelligent security protection, a possible target has to be filtered out from massive image data. However, in a related solution, when solving a crime using images in a surveillance video, a massive portrait library has to be searched according to an image of an unidentified suspect. Source videos are checked one by one, and captured images of a target object are manually studied one by one to determine whether the target object is the suspect. Such manual checking is slow and has a low recall rate.

### SUMMARY

Embodiments of the disclosure relate to the field of machine vision, and more particularly, to a method and device for archive application, and a non-transitory computer-readable storage medium.

According to a first aspect, provided is a method for archive application, including: acquiring target time and space range information; determining, based on the target time and space range information, at least one target clustered archive in a clustered archive library, wherein the at least one target clustered archive matches the target time and space range information, each of the at least one target clustered archive includes archive information of a respective acquisition object, and the archive information includes activity time and space range information of the respective acquisition object; and performing a predetermined operation based on the at least one target clustered archive.

According to a second aspect, provided is a device for archive application, including: an acquisition module configured to acquire target time and space range information; a determination module configured to determine, based on the target time and space range information, at least one target clustered archive in a clustered archive library, wherein the at least one target clustered archive matches the target time and space range information, each of the at least one target clustered archive includes archive information of a respective acquisition object, and the archive information includes activity time and space range information of the respective acquisition object; and an operation module configured to perform a predetermined operation based on the at least one target clustered archive.

According to a third aspect, provided is a device for archive application including: a memory configured to store computer-executable instructions; and a processor connected to the memory and configured to execute the computer-executable instructions to: acquire target time and space range information; determine, based on the target time and space range information, at least one target clustered archive in a clustered archive library, wherein the at least one target clustered archive matches the target time and space range information, each of the at least one target clustered archive includes archive information of a respective acquisition object, and the archive information includes activity time and space range information of the respective acquisition object; and perform a predetermined operation based on the at least one target clustered archive.

According to a fourth aspect herein, provided is a non-transitory computer-readable storage medium having stored thereon computer-executable instructions that, when executed by a processor, implement following: acquiring target time and space range information; determining, based on the target time and space range information, at least one target clustered archive in a clustered archive library, wherein the at least one target clustered archive matches the target time and space range information, each of the at least one target clustered archive includes archive information of a respective acquisition object, and the archive information includes activity time and space range information of the respective acquisition object; and performing a predetermined operation based on the at least one target clustered archive.

### BRIEF DESCRIPTION OF THE DRAWINGS

FIG. 1 illustrates a flowchart of a method for archive application according to embodiments of the disclosure.

FIG. 2 illustrates a first flowchart of generating a clustered archive library according to embodiments of the disclosure.

FIG. 3 illustrates a second flowchart of generating a clustered archive library according to embodiments of the disclosure.

FIG. 4 illustrates a diagram of an example of the method for archive application according to embodiments of the disclosure.

FIG. 5 illustrates a diagram of an example of receiving a time and space filtering techniques-and-tactics instruction by a device for archive application according to embodiments of the disclosure.

FIG. 6 illustrates a diagram of an interface for receiving a parameter configuration in time and space filtering techniques and tactics by a device for archive application according to embodiments of the disclosure.

FIG. 7 illustrates a schematic structural diagram of a device for archive application according to embodiments of the disclosure.

FIG. 8 illustrates a schematic diagram of a physical structure of a device for archive application according to embodiments of the disclosure.

### DETAILED DESCRIPTION

The technical solution of the disclosure will be further elaborated below in conjunction with the accompanying drawings and particular embodiments.

Embodiments of the disclosure are intended to provide a method and device for archive application, and a storage medium, so that a target object having appeared in specified time and space can be found automatically for behavior analysis, improving processing efficiency and saving human resources.

The method includes: acquiring target time and space range information; determining, based on the target time and space range information, at least one target clustered archive in a clustered archive library, wherein the at least one target clustered archive matches the target time and space range information, each of the at least one target clustered archive includes archive information of a respective acquisition object, and the archive information includes activity time and space range information of the respective acquisition object; and performing a predetermined operation based on the at least one target clustered archive. That is, in the embodiments of the disclosure, after acquiring the target time and space range information, the preset clustered archive library will be queried and searched. By means of the activity time and space range information of the acquisition object recorded in the archive information of clustered archives in the clustered archive library, the device for archive application can automatically and quickly find out the target clustered archive having appeared in the specified target time range and space range. A target clustered archive corresponds to a respective target object, so that it is not necessary to process the pictures one by one when the information of some objects needs to be retrieved. A staff does not have to look at the captured pictures or videos one by one. The device for archive application herein can learn which acquisition object has ever appeared in the target time and space range directly according to the archive information in the clustered archive, which has the advantage of high efficiency. Meanwhile, compared to manual judgment, manual errors, and mistakes or omissions caused by an unskilled person are reduced, rendering high accuracy and high recall rate.

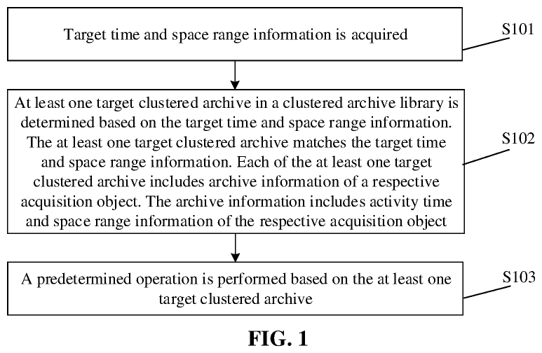

FIG. 1 illustrates a flowchart of a method for archive application according to embodiments of the disclosure. As illustrated in FIG. 1, the method for archive application may include the following actions S101 to S103.

In S101, target time and space range information is acquired.

In S102, at least one target clustered archive in a clustered archive library is determined based on the target time and space range information. The at least one target clustered archive matches the target time and space range information. Each of the at least one target clustered archive includes archive information of a respective acquisition object. The archive information includes activity time and space range information of the respective acquisition object.

In S103, a predetermined operation is performed based on the at least one target clustered archive.

In embodiments of the disclosure, the method for archive application is applied to a device for archive application. Exemplarily, the device for archive application may be located in an electronic device such as a terminal device or a server. A terminal device may be user equipment (UE), a mobile device, a terminal, etc.

In S101 according to embodiments of the disclosure, the device for archive application acquires the target time and space range information based on a user operation configuration, or may acquire the target time and space range information by receiving the target time and space range information carried in an alarm instruction from another device. The target time and space range information serves to indicate a target object appearing in both a specified time range and a specified space range. Exemplarily, the target time and space range information may include target time range information and/or target space range information.

It should be noted that, in embodiments of the disclosure, the target time and space range information includes time information and location information of a security event. A security event includes a burglary event, an anti-terrorism monitoring event, a medical disturbance event, an accident event, etc.

Exemplarily, when the method for archive application according to the embodiments of the disclosure is used for checking about a security event, witness 1 claims to have seen suspect A in school Y between 19:00 on May 24, 2018 and 19:00 on May 26, 2018. Witness 2 claims to have seen suspect A at the surrounding of school Y at 14:00 on May 25, 2018. Witness 3 claims to have seen suspect A at the surrounding of school Y between May 26, 2018 and 19:00, May 28, 2018. In embodiments of the disclosure, the target time range in the target time and space range information may include: 19:00, May 24, 2018 to 19:00, May 28, 2018, and the target space range in the target time and space range information may be: school Y and the surrounding of school Y.

In S102 according to embodiments of the disclosure, the device for archive application compares activity time and space range information of an acquisition object contained in archive information in a clustered archive with the target time and space range information. If the activity time and space range information of the acquisition object falls within the target time and space range information, the clustered archive is determined as the target clustered archive needing to be filtered out.

It should be noted that, in embodiments of the disclosure, each acquisition object corresponds to a unique clustered archive. That is, one clustered archive corresponds to one acquisition object, and one target clustered archive corresponds to one acquisition object.

In some optional embodiments, the archive information records not only the activity time and space range information of the acquisition object, but also records activity attribute information of the acquisition object. Exemplarily, if the acquisition object is a vehicle, the archive information records not only travel time information and/or space information of the vehicle, but also activity attribute information such as the number of times that the vehicle runs a red light, whether the vehicle crosses a pedestrian crosswalk, etc., within the corresponding time and/or space. If the acquisition object is a person, the archive information records not only activity time and/or space information of the person, but also information such as dressing information, the hair length, and the hair color of the person within the corresponding time and/or space.

In some optional embodiments, a clustered archive records historically complete archive information of the acquisition object. In some other optional embodiments, considering the storage space, the clustered archive may record part of the archive information of the acquisition object. The part of archive information is divided according to the time range and/or the regional range with respect to the historically complete archive information.

In addition, in embodiments of the disclosure, by the at least one target clustered archive in the clustered archive library that matches the target time and space range information, it means that the time information and the space information in the activity time and space range information of the acquisition object corresponding to the at least one target clustered archive fall within the target time range and the target space range of the target time and space range information.

In embodiments of the disclosure, the clustered archive library may be acquired by the device for archive application from another device, or may be obtained in advance by the device for archive application through analysis with image processing technology.

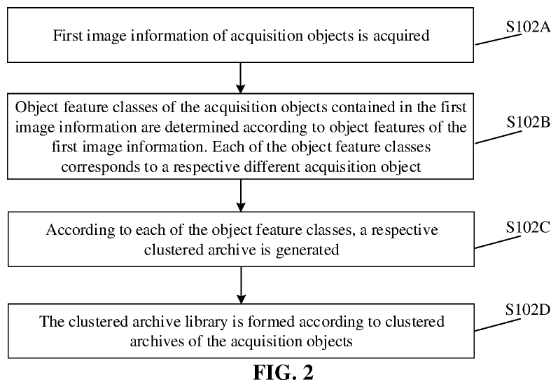

FIG. 2 illustrates a first flowchart of generating a clustered archive library according to embodiments of the disclosure. As illustrated in FIG. 2, the method in which the device for archive application acquires a clustered archive library may include the following actions.

In S102A, first image information of acquisition objects is acquired.

In S102B, object feature classes of the acquisition objects contained in the first image information are determined according to object features of the first image information. Each of the object feature classes corresponds to a respective different acquisition object.

In S102C, according to each of the object feature classes, a respective clustered archive is generated.

In S102D, the clustered archive library is formed according to clustered archives of the acquisition objects.

In this embodiment, an image processing scheme is used to classify the first image information acquired, to obtain the feature class of the acquisition object, instead of manually classifying the information of the acquisition objects, which saves lots of human costs, and improves the accuracy of classification.

In an embodiment of the disclosure, in S102A, the device for archive application may acquire the first image information using a camera within a specified space range within a specified time range. The specified space range may include the target space range in the target time and space range information. The specified time range may include the target time range.

Exemplarily, the device for archive application selects a first video source, a second video source, and a third video source that include the target time and space range information. Image information in the school Y from May 24, 2018 to May 25, 2018 is recorded in the first video source. Image information at a first photography location around the school Y from May 21, 2018 to May 31, 2018 is recorded in the second video source. Image information at a second photography location around the school Y from May 21, 2018 to May 28, 2018 is recorded in the third video source. The image information recorded in the three video sources may be the first image information in the embodiments of the disclosure.

In S102B according to embodiments of the disclosure, the device for archive application extracts an object feature of the acquisition object in the first image information. The acquisition object may be, for example, a person or a vehicle. The acquisition object may also be another type of object, which is not limited here.

In some optional embodiments, with the acquisition object being a person as an example, the device for archive application may determine the person feature class of an image by clustering according to the person features in the first image information. Optionally, a person feature may include a face feature of a person.

However, because a face image in the acquired first image information may be occluded, unevenly lighted, with a cluttered background, distorted, of low contrast, askew, too large or too small, etc., the clustering may fail. Therefore, to improve the effect of clustering, in some other optional embodiments, the person feature may include a face feature and a body feature. The device for archive application determines the person feature class of images based on the body feature and the face feature in the first image information. Exemplarily, a body feature may refer to a hair feature, a dressing feature, etc. It is understandable that, in embodiments of the disclosure, the recall rate is improved by clustering according to both the face feature and the body feature.

In another embodiment, the device for archive application may determine, by incremental clustering based on the object feature of the first image information, the object feature class of the acquisition object contained in the first image information.

Exemplarily, with the acquisition object being a person as an example, the device for archive application may determine a person feature class of the image to be processed, according to the person feature of the image to be processed and a class center feature of the person feature class. When the image to be processed belongs to a known person feature class, the class center feature of the person feature class is updated according to the face feature and multiple pieces of feature information of the person feature class, thus implementing incremental clustering of the image to be processed.

As an example, multiple pieces of first image information acquired by the camera may be obtained at a preset time interval. Feature values of face features of the multiple pieces of first image information may be determined. A person feature class may be determined according to the feature values of the face features. When there is no such a person feature class, the feature value of any one of the face features of the first image information may be used as the class center of the person feature class. A feature value of the face feature of another piece of first image information may be compared to the class center; and if the difference between the feature value of the face feature of the another piece of first image information and the class center is within a preset difference range, the another piece of first image information may be classified into the person feature class, and the class center of the person feature class may be determined anew.

For example, the average of the feature value of the face feature of the another piece of first image information and the class center may be used as a new class center of the person feature class. If the difference between the feature value of the face feature of the another piece of first image information and the class center exceeds the preset difference, the another piece of first image information may be classified into a new person feature class. It is understandable that the incremental clustering algorithm reduces the number of comparison times and improves the speed of clustering.

In some optional embodiments, in a scenario of massive data, in order to ensure sufficient computing capability, the device for archive application may also implement the above solution using a Graphics Processing Unit (GPU) in parallel.

In embodiments of the disclosure, the device for archive application determining the object feature class of the acquisition object means classifying part of the first image information belonging to the same object into a same class. If the acquisition object is a person, this process is also referred to as pedestrian library clustering.

In embodiments of the disclosure, after acquiring the object feature class of the acquisition object, the device for archive application may generate a clustered archive corresponding to the object feature class. Clustered archives of different acquisition objects form a clustered archive library.

It should be noted that, in embodiments of the disclosure, the object feature class includes acquired information corresponding to multiple pieces of first image information of the acquisition object, i.e., the acquired time information and space information which correspond to the time range information and the space range information of activity of the acquisition object. The acquired information is the archive information.

In some optional embodiments, the object feature class may also include multiple pieces of first image information of the acquisition object. That is, the clustered archive may include multiple pieces of first image information of the acquisition object. Of course, cluster features of the multiple pieces of first image information may be stored in form of feature data as well, to reduce storage space.

As mentioned above, the archive information of the clustered archive includes time information and space information of activity of the acquisition object. Exemplarily, In embodiments of the disclosure, the clustered archive A of an object A records activity attributes of the object A from 19:00:00 on May 24, 2018 to 19:00:00 on May 28, 2018, such as: {2018/5/24/20:10:00-school Y, . . . , 2018/5/25/14:10:00-photography location 1 around school Y, . . . , 2018/5/27/10:00:00-community D, . . . , 2018/5/28/19:00:00-photography location 2 around school Y}. The clustered archive B of an object B records activity attributes of the object B from 19:00:00 on May 24, 2018 to 19:00:00 on May 28, 2018, such as: {2018/5/24/19:00:00-community D, . . . , 2018/5/26/17:00-school Y, . . . , 2018/5/27/10:15:00-community X, . . . 2018/5/28/13:00:00-photography location 1 around school Y}. The clustered archive C of an object C records activity attributes of the object C from 19:00:00 on May 24, 2018 to 19:00:00 on May 28, 2018, such as: {2018/5/24/10:00:00-community E, . . . , 2018/5/26/:00-14:00:00-school F, . . . , 2018/5/28/00:15:00-community X, . . . 2018/5/28/16:20:00-Square M}. The clustered archive D of an object D records activity attributes of the object D from 19:00:00 on May 24, 2018 to 19:00:00 on May 28, 2018, such as: {2018/5/24/20:00:00-photography location 1 around school Y, . . . , 2018/5/26/14:00:00-school F, 2018/5/27/14:00-school Z, . . . , 2018/5/28/10:15:00-community X, . . . 2018/5/28/19:00:00-school Y}. A time range (including a moment) and a space range (including a location) correspond to an activity event of the object. For example, “2018/5/28/19:00:00-school Y” in the clustered archive of object D represents an active event. It should be noted that the aforementioned clustered archive A to clustered archive D are a portion of clustered archives in the clustered archive library.

In some other optional embodiments, in order to confirm the identity of the acquisition object, when constructing the clustered archive of the acquisition object, the identity of the acquisition object may also be authenticated. Namely, the identity information of the acquisition object is obtained. Therefore, the archive information records the time information and space information of activities of the acquisition object, as well as the identity information of the acquisition object.

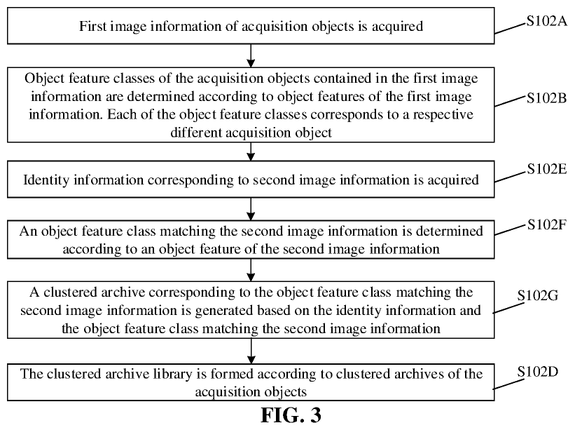

FIG. 3 illustrates a second flowchart of generating a clustered archive library according to embodiments of the disclosure, which may include the following actions.

In S102A, first image information of acquisition objects is acquired.

In S102B, object feature classes of the acquisition objects contained in the first image information are determined according to object features of the first image information. Each of the object feature classes corresponds to a respective different acquisition object.

In S102E, identity information corresponding to second image information is acquired.

In S102F, an object feature class matching the second image information is determined according to an object feature of the second image information.

In S102G, a clustered archive corresponding to the object feature class matching the second image information is generated based on the identity information and the object feature class matching the second image information.

In S102D, the clustered archive library is formed according to clustered archives of the acquisition objects.

In this embodiment, the identity information is introduced into the clustered archive in an image processing scheme, so that during subsequent application based on the clustered archive, the identity information of the acquisition object can be easily obtained, providing more useful information during criminal investigation, thereby accurately focusing on a target object.

In the action S102E implemented in the present disclosure, the device for archive application may acquire identity information corresponding to second image information. There is correspondence between the second image information and the identity of the object represented by the second image information.

Illustratively, with the acquisition object being a person as an example, the device for archive application may acquire person image information and corresponding identity information stored in the police system, which is also referred to as a portrait library. The identity information here may be information such as the name, gender, age, ID number, and a criminal record of an acquisition object. The person image information stored in the police system is the second image information.

However, in embodiments of the disclosure, since there are many portrait libraries in the police system, in order to avoid missing or repeated identity comparison, multiple portrait libraries may be aggregated. For example, the police system includes a library of permanent residents, a library of drug abusers, and a library of floating population. In order to obtain a more comprehensive portrait library, the device for archive application may aggregate information belonging to the same object in all the portrait libraries, to provide more comprehensive identity information of the acquisition object.

In embodiments of the disclosure, based on object feature classes and the second image information, the device for archive application may extract an object feature in the second image information and then compare the object feature of the second image information with features of the object feature classes, to determine an object feature class matching the second image information, and to obtain the identity information corresponding to the object feature class. For example, with the acquisition object being a person as an example, the device for archive application may extract the face feature of a face image in the second image information, and then compare the feature value of the extracted face feature to the center feature value of the class center of each person feature class, to determine a person feature class most similar to the feature value of the face feature. If the similarity corresponding to the most similar person feature class is greater than a preset value, for example, greater than 95%, identity information of the face image may be classified into the archive information of the clustered archive corresponding to the most similar person feature class. It should be noted that the above process of determining the identity information corresponding to the person feature class based on the face feature of the face image in the second image is also referred to as library hitting between the pedestrian library and the portrait library.

In addition, in embodiments of the present disclosure, when the identity information corresponding to the second image information is updated, for example: no name has been recorded previously, but name information is added now, the device for archive application will update identity information of the acquisition object in archive information of the clustered archive synchronously. This process may be referred to as incremental library hitting.

In S102G according to embodiments of the disclosure, after determining identity information of acquisition objects corresponding to object feature classes, the device for archive application may generate a clustered archive corresponding to each object feature class based on the object feature class and identity information corresponding to the object feature class. Clustered archives corresponding to different acquisition objects form the clustered archive library of embodiments of the present disclosure.

Exemplarily, there are object A-object D in the clustered archive library that includes the identity information of acquisition objects: the object A-{Zhang San-male-ID No. 0000001: 2018/5/24/20:10:00-school Y, . . . , 2018/5/25/14:10:00-photography location 1 around school Y, . . . , 2018/5/27/10:00:00-community D, . . . 2018/5 /28/19:00:00-photography location 2 around school Y}; the object B-{Li Si-female-ID No. 0000002: 2018/5/24/19:00:00-community D, . . . , 2018/5/26/17:00-school Y, . . . , 2018/5/27/10:15:00-community X, . . . 2018/5/28/13:00:00-photography location 1 around school Y}; the object C-{Liu Wu-male-ID No. 0000003: 2018/5/24/10:00:00-community E, . . . , 2018/5/26/:00-14:00:00-school F, . . . , 2018/5/28/00:15:00-community X, . . . 2018/5/28/16:20:00-square M}; and the object D-{Li Liu-male-ID No. 0000004: 2018/5/24/20:00:00-photography location 1 around school Y, . . . , 2018/5/26/14:00:00-school F, . . . , 2018/5/27/14:00-school Z, . . . , 2018/5/28/10:15:00-community X, . . . 2018/5/28/19:00:00-school Y}.

With the above-mentioned method for generating clustered archives in the clustered archive library in embodiments of the present disclosure, with the acquisition object being a person as an example, acquired information of the same acquisition object in different video sources is integrated together through face and body incremental clustering and is associated to a police portrait library, to generate the clustered archive corresponding to the same acquisition object. In the related art, video sources have to be processed one by one, and each frame of person image in the video sources is compared to the portrait library of the police system (1: N), to obtain the identity information corresponding to each single frame of person image; and then captured information belonging to the same person is classified piece by piece based on confirmed identity information. Comparatively, the method according to the embodiments of the disclosure not only improves the recall rate, but also speeds up clustered archive construction.

It should be noted that, in embodiments of the present disclosure, after the clustered archive library has been formed through the solution illustrated in FIG. 2 or FIG. 3, the archive library may be classified based on the time and space range information and/or identity information contained in the archive information. Of course, a classified library may also be further divided into sub-libraries. The form of dividing a clustered archive library is not limited in embodiments of the present disclosure.

In an embodiment, after the clustered archive library has been classified and divided into sub-libraries, the device for archive application implemented in the present disclosure may screen out a target clustered archive based on the clustered archive library by narrowing down a screening range of the clustered archive library by presetting a clustered archive library, to improve the search speed.

In this embodiment, the clustered archive library may be determined as follows. First selection information indicating a clustered archive library to be selected is received. Second selection information indicating exclusion of a sub-library from the clustered archive library to be selected is received. The clustered archive library is determined according to the first selection information and the second selection information.

It is understandable that, by narrowing down a screening range of the clustered archive library by presetting clustered archive library, the search speed of the target clustered archive can be improved.

It should be noted that, in embodiments of the present disclosure, the first selection information and the second selection information may be received by the device for archive application based on configuration provided by a user.

Exemplarily, when the clustered archive library to be selected indicated by the first selection information is a classified clustered archive library of criminal histories, and the second selection information indicates the resident population sub-library in the clustered archive library of criminal histories, the clustered archive library determined by the device for archive application is: the clustered archive library of criminal histories excluding clustered archives corresponding to acquisition objects in the resident population sub-library.

In S102 herein, according to the above example, based on the set target time and space range information, the device for archive application determines that the clustered archives of object A, object B, and object D all match the target time and space range information.

Therefore, in embodiments of the present disclosure, the target clustered archives matching the target time and space range information are all filtered out by activity time and space range information of the acquisition objects in the clustered archives.

It is understandable that, in embodiments of the present disclosure, a clustered archive includes archive information corresponding to an acquisition object. Based on the clustered archive library, the device for archive application may filter out a clustered archive corresponding to a target acquisition object having appeared in the target time range and/or the target space range.

In S103 according to the embodiments of the present disclosure, having filtered out the clustered archive, the device for archive application may perform behavior analysis based on the target clustered archive filtered out. In some optional embodiments, the archive information includes identity information of the respective acquisition object. S103 may include that the device for archive application outputs identity information of an acquisition object in the at least one target clustered archive based on the at least one target clustered archive.

It is understandable that in monitoring deployment for security protection, by outputting the identity information in the archive information, identity of the target acquisition object can be found out quickly, so as to acquire more identity information of the target acquisition object, such as age, gender, and a historical criminal record, etc., On the other hand, monitoring deployment is facilitated based on the identity information learnt.

In embodiments of the present disclosure, since the archive information records activity time and space range information of the acquisition object, as well as identity information of the acquisition object, the device for archive application may output the identity information of the acquisition object as needed by the user.

Exemplarily, in embodiments of the present disclosure, the device for archive application outputs activity time and space range information of the object A, so as to analyze the behavior feature of the object A according to activity time and space range information of the object A. Meanwhile, the person identity may be quickly learned by outputting the identity information of the object A, which helps learning the historical criminal record of the object A on one hand, and facilitates monitoring deployment on the other hand.

In some optional embodiments, S103 includes that the device for archive application outputs, based on first identity information in the at least one target clustered archive, archive information of a target clustered archive that matches preset second identity information.

In embodiments of the present disclosure, the identity information of the acquisition object is stored in the clustered archive. For example, the archive information obtained in S102 may include the ID numbers of the objects A to D. When the preset second identity information is 0000001, the device for archive application determines that the object A matches the preset second identity information, and thus outputs activity time and space range information of the object A or outputs the archive number corresponding to the object A.

It should be noted that in embodiments of the present disclosure, the first identity information and the preset second identity information do not need to be completely consistent in type, as long as they both may uniquely represent an identity. For example, when the first identity information is the ID number in the archive, the preset second identity information may also be the passport number associated with the ID number. Through the unique relationship between the passport number and the ID number, the clustered archive matching the passport number may be found.

It is understandable that after obtaining the clustered archive of the acquisition object that has appeared in all of different target time and space ranges, the device for archive application may learn the identity of the acquisition object based on the identity information recorded in the clustered archive. In solving a case, a police officer can quickly query the clustered archive of the target object based on second identity information grasped, and analyze the behavior feature of the target object based on the archive information in the clustered archive, saving lots of human costs and prime time for solving the case.

In an embodiment, S103 includes that the device for archive application outputs, based on the at least one target clustered archive. A part of archive information of a subset of the at least one target clustered archive, and activity time indicated by activity time and space range information of each acquisition object in the subset is within a preset time range. Alternatively, an activity range indicated by the activity time and space range information of each acquisition object in the subset is within a preset space range. Alternatively, the activity time indicated by the activity time and space range information of each acquisition object in the subset is within the preset time range, and the activity range indicated by the activity time and space range information of each acquisition object in the subset is within the preset space range.

In embodiments of the present disclosure, the device for archive application supports result query, and outputs, according to activity time and space range information of the acquisition object recorded in the archive information in the clustered archive (for example, the target clustered archive), part of the archive information in the clustered archive having appeared in a specified time range, or part of the archive information in the clustered archive having appeared in a specified space range, and part of the archive information having appeared in both the specified time range and the specified space range.

Exemplarily, in embodiments of the present disclosure, the preset time range may be 19:00 on May 24, 2018 to 19:00 on May 25, 2018, and the preset space range may be the photography location 1 around school Y. The device for archive application outputs part of the archive information in a matching clustered archive according to the preset time range and/or the preset space range.

It is understandable that when the embodiments of the present disclosure are applied to security event investigation, the device for archive application supports local query in a preset time range and/or a preset space range, so that a staff can analyze the suspect's motive in more details according to information of the suspect's activity within the time range and the location range where the case occurs.

In some optional embodiments, each target clustered archive includes at least one activity event. Each activity event includes time and space range information. S103 includes: in response to that there are at least two target clustered archives, time and space range information in activity events in the at least two target clustered archives is matched to the target time and space range information, to determine a number of matching activity events in each of the at least two target clustered archives; and the at least two target clustered archives are sequentially output in a descending order of the number of matching activity events.

In embodiments of the present disclosure, the device for archive application supports sequential output. Exemplarily, in S102, the device for archive application determines that the archive information of the object A, the object B, and the object D all match the target time and space range information. As the time and space range information of three activity events in the archive information of object A falls within the target time and space range information, and the time and space range information of two activity events in the archive information of each of object B and object D falls within the target time and space range information, the device for archive application firstly outputs the clustered archive of object A, and then outputs the clustered archives of object B and object D.

It is understandable that outputting target clustered archives in a descending order of the number of matching activity events can ensure that the target clustered archive output earliest may correspond to the target object that needs the most attention. For example, a person who has appeared in multiple security events may be a habitual offender, and therefore needs more attention.

In some other optional embodiments, S103 includes: in response to that there are at least two target clustered archives containing a same number of matching activity events, the at least two target clustered archives containing the same number of matching activity events are sequentially output in a temporal order corresponding to the time and space range information in activity events in the at least two target clustered archives containing the same number of matching activity events.

Exemplarily, the device for archive application determines that the archive information of both the object B and the object D contains two activity events corresponding to which the time and space range information falls within the target time and space range information. The latest time of the activity events recorded in the archive information of object B is 2018/5/28/13:00:00. The latest time of the activity events recorded in the archive information of object D is 2018/5/28/19:00:00. Therefore, as needed, for example in the case where the current time is 2018/5/28/22:00, and monitoring deployment needs to be performed for the suspect, outputting the clustered archive of object D firstly and then outputting the clustered archive of object B may ensure that the monitoring deployment is performed according to the time and space range information in the archive information of object D preferentially. The effectiveness of monitoring deployment is ensured.

It is understandable that, in embodiments of the present disclosure, in case of target clustered archives containing a same number of matching activity events, deciding the order of outputting the target clustered archives intentionally according to a temporal order allows the user to immediately view a target clustered archive requiring more attention and perform a corresponding operation.

It should be noted that, in embodiments of the present disclosure, in case of multiple target clustered archives containing a same number of matching activity events, the order in which the target clustered archives are output may not be limited to the above. The target clustered archives may also be output in a temporal order in a set time range. Alternatively, the output may also be determined in combination with space information.

In some optional embodiments, S103 includes that the device for archive application outputs, according to the at least one target clustered archive, archive information of an acquisition object in a temporal order.

In embodiments of the present disclosure, after determining the target clustered archive needing to be output, the device for archive application may output the archive information of an acquisition object in temporal order based on activity time information of the acquisition object recorded in the archive information in the target clustered archive.

Exemplarily, the archive information of object A may be output in reverse chronological order, so as to better perform monitoring deployment, or the archive information of object A may be output in chronological order, so as to analyze the historical behavior of object A to decide a possibility of the object committing a crime.

In some optional embodiments, since there may be multiple target clustered archives matching the target time and space range information, the device for archive application may output archive numbers corresponding to a preset number of target clustered archives, for friendliness of display.

In some optional embodiments, in displaying the archive information in the clustered archives, the device for archive application may also display the archive information in different clustered archives or in the same clustered archive in a paged form according to the time range or the space range, to improve the display effect.

In some other optional embodiments, S103 includes that: the device for archive application outputs, according to time and space range information contained in the at least one target clustered archive, an activity track of an acquisition object.

It is understandable that through the archive information in the target clustered archive, the activity track of the acquisition object is obtained. The police may solve the case by performing analysis according to the activity track to obtain the activity pattern of the acquisition object, which helps the police connecting the clues and analyzing the case, thus improving case solving efficiency.

In embodiments of the present disclosure, as activity time and space range information of the acquisition object is recorded in the target clustered archive, the device for archive application may output the activity track of the acquisition object according to the time range information and/or the space range information of activities, facilitating subsequent tracking.

Exemplarily, in embodiments of the present disclosure, after determining the clustered archive of the object A, track data of the object A may be analyzed to obtain the activity pattern of the object A, which helps the police connecting the clues to analyze the case, improving the efficiency in case solving.

In some other optional embodiments, after the device for archive application has determined the track of the acquisition object, the method may further include that: the device for archive application determines a start point and an end point of the activity track of the acquisition object; and displays, on an electronic map, the start point and the end point of the activity track of the acquisition object.

In embodiments of the present disclosure, after determining the track of the acquisition object, the start point and the end point of the activity track of the acquisition object may be determined, and then displayed on the electronic map. In the process of criminal investigation and case solving, positioning of the start point and the end point of the track helps the police in performing monitoring deployment to arrest the suspect.

It is understandable that, in embodiments of the present disclosure, based on activity time and space range information of the acquisition object stored in the archive information of the target clustered archive, the device for archive application can automatically obtain a target object that has appeared in the specified target time and space range, and conduct behavior analysis based on the clustered archive of the target object, thereby providing the user with an effective reference, saving human resources while improving efficiency.

The following is an example of applying the method for archive application to security event investigation. The police usually analyzes and confirms a suspect through video investigation. During video image analysis, techniques and tactics are often used. Techniques and tactics refer to a method for strategy selection. With different analysis strategies such as time and space filtering techniques and tactics combining time and space, a target person, a target vehicle, and the like may be checked. With continuous development of technology, techniques and tactics are combined with artificial intelligence in smart security protection, so that the device for archive application can perform smart analysis with the “mind of police”.

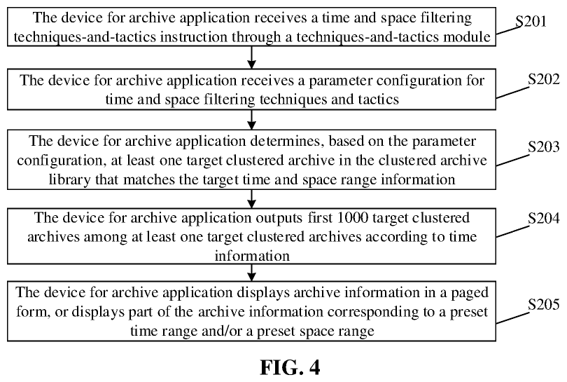

FIG. 4 illustrates a diagram of an example of the method for archive application according to embodiments of the disclosure. As illustrated in FIG. 4, in embodiments of the present disclosure, the device for archive application may implement the method for archive application including actions S201-S205 as follows.

In S201, the device for archive application receives a time and space filtering techniques-and-tactics instruction through a techniques-and-tactics module.

In embodiments of the present disclosure, a techniques-and-tactics module may be preset in the device for archive application. A variety of techniques-and-tactics strategies are stored in the techniques-and-tactics module. The device for archive application supports expansion of techniques-and-tactics strategies. The device for archive application receives time and space filtering techniques-and-tactics instructions sent by the user based on an operation interface.

It should be noted that, in embodiments of the present disclosure, the time and space filtering techniques-and-tactics instructions are used to indicate the device for archive application to use a time and space filtering techniques-and-tactics strategy. That is, the device for archive application needs to filter out the target clustered archive matching the specified time range and the specified space range.

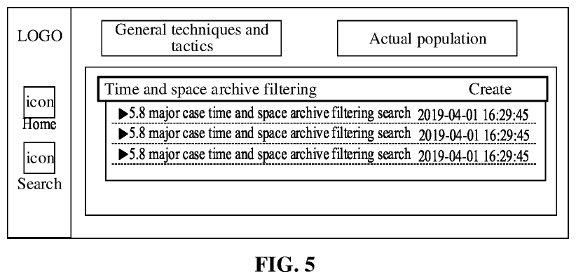

FIG. 5 illustrates a diagram of an example of receiving time and space filtering techniques-and-tactics instructions by a device for archive application according to embodiments of the disclosure. As illustrated in FIG. 5, the device for archive application creates, based on a user's selection operation on the interface, a time and space filtering techniques-and-tactics event. For example, a time and space filtering techniques-and-tactics event named “5.8 major case time and space archive filtering search” is created. In embodiments of the present disclosure, time and space filtering techniques-and-tactics refer to filtering the clustered archive library based on time and space constraints, performing analysis to obtain the target clustered archive of the target object having appeared under the defined time and space conditions, and performing a predetermined operation based on the target clustered archive.

In S202, the device for archive application receives a parameter configuration for time and space filtering techniques and tactics, including at least one of the following: a time range, a location (corresponding to the image acquisition area of the video source), a library to be selected, a library to be excluded, a case, a case number, notes, etc.

In embodiments of the present disclosure, after receiving the time and space filtering techniques-and-tactics instructions, the device for archive application will further receive a parameter configured by the user, including at least one of the following: a condition parameter, an identification parameter, etc. The condition parameter refers to the configuration of a basic parameter based on the time and space filtering techniques-and-tactics, such as the time and space filtering information to be selected, including: a filter time range, a filter location (corresponding to the image acquisition area of the video source), and a library to be hit. The identification parameter is used to record and identify event information corresponding to the processing operations of the device for archive application, such as to record the case number, the target archive to be focused on, etc.

It should be noted that, in embodiments of the present disclosure, the time range and the area range configured by the user received by the device for archive application are the target time and space range information. The configuration of the library to be selected and the library to be excluded corresponds to the clustered archive libraries chosen in the interface.

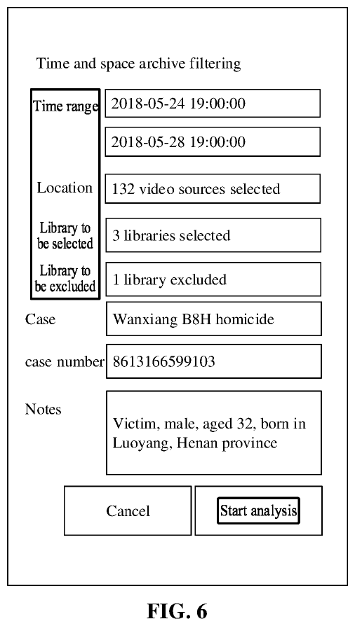

Exemplarily, FIG. 6 illustrates a diagram of an interface for receiving a parameter configuration in time and space filtering techniques and tactics by a device for archive application according to embodiments of the disclosure. As illustrated in FIG. 6, based on the configuration provided by the user, the device for archive application receives the time and space filtering information: the filter time range is 2018-05-24 19:00:00 to 2018-05-28 19:00:00, and the filter space range is the 132 video sources selected. The time range corresponds to target time range information, and the space range corresponds to target space range information. It may also be seen from the interface of FIG. 6 that the selected clustered archive libraries include 3 library sets, and one sub-library is excluded from a certain one of the three library sets. Identification parameters are as follows:

Case: Wanxiang BBH homicide

Case number: 8613166599103

Notes (target archive): victim, male, aged 32, born in Luoyang, Henan province

In embodiments of the present disclosure, after making configurations based on the above parameters, the device for archive application performs analysis based on a clicked start analysis command.

In S203, the device for archive application determines, based on the parameter configuration, at least one target clustered archive in the clustered archive library that matches the target time and space range information.

In S204, the device for archive application outputs first 1000 target clustered archives among at least one target clustered archives according to time information.

In embodiments of the present disclosure, because there may be multiple target clustered archives matching the target time and space range information as determined by the device for archive application, the device for archive application outputs the first 1000 target clustered archives following the chronological order or reverse chronological order corresponding to the time and space range information in the target clustered archives.

It should be noted that, in the embodiments of the present disclosure, the device for archive application may also sequentially output multiple target clustered archives in a descending order of the number of activity events contained in the target clustered archives. Activity time and space range information of the activity events matches with the target time and space range information. When the number of matching activity events contained in different target clustered archives are identical, the device for archive application may sequentially output the target clustered archives in a temporal order of the activity events matching the target time and space range information, until first 1000 target clustered archives are output.

In S205, the device for archive application displays archive information in a paged form, or displays part of the archive information corresponding to a preset time range and/or a preset space range.

In embodiments of the present disclosure, because in most cases, the archive information records the long-term activity time range information of the acquisition object, the amount of data in a target clustered archive will be large. The device for archive application will display archive information in a paged form, and display a corresponding part of archive information according to a preset time range and/or a preset space range.

When the embodiments of the present disclosure are applied to striking drug-related crimes, after destroying a drug-taking den 0, all people having appeared in the drug-taking den 0 within a certain period of time may be found via time and space filtering, to prevent escaped criminal.

It is understandable that, in embodiments of the present disclosure, with the help of the set target time and space range information, the device for archive application is allowed to automatically obtain, with no photo of the suspect, a target suspect ever appeared in the designated target time and space range based on the activity time and space range information of the acquisition object stored in the clustered archive, thereby providing an effective reference for the police, saving human resources while improving efficiency.

As illustrated in FIG. 7, also provided is a device for archive application, including: an acquisition module 110, a determination module 120 and an operation module 130.

The acquisition module 110 is configured to acquire target time and space range information.

The determination module 120 is configured to determine, based on the target time and space range information, at least one target clustered archive in a clustered archive library. The at least one target clustered archive matches the target time and space range information, each of the at least one target clustered archive includes archive information of a respective acquisition object, and the archive information includes activity time and space range information of the respective acquisition object.

The operation module 130 is configured to perform a predetermined operation based on the at least one target clustered archive.

The device for archive application provided in the embodiment may be applied to various electronic devices, such as a mobile device or a fixed device. The mobile device includes, but is not limited to, a mobile phone, a tablet computer, or various kinds of wearable devices. The fixed device includes, but is not limited to, a desktop notebook, a server, or the like.

In some embodiments, the acquisition module 110, the determination module 120, and the operation module 130 may be program modules that, when executed by a processor, can determine an archive matching at least two pieces of target time and space information, and perform a predetermined operation according to the archive.

In some other embodiments, the acquisition module 110, the determination module 120, and the operation module 130 may be a combination of software and hardware that may include various programmable arrays. The programmable arrays include but are not limited to complex programmable arrays or field programmable arrays.

In some embodiments, the operation module 130 is configured to: output, based on the at least one target clustered archive, identity information of an acquisition object in the at least one target clustered archive.

In some embodiments, the operation module 130 is configured to: output, based on first identity information in the at least one target clustered archive, archive information of a target clustered archive that matches preset second identity information.

In some embodiments, the operation module 130 is configured is configured to: output, based on the at least one target clustered archive, a part of archive information of a subset of the at least one target clustered archive. An activity time indicated by activity time and space range information of each acquisition object in the subset is within a preset time range. Alternatively an activity range indicated by the activity time and space range information of each acquisition object in the subset is within a preset space range. Alternatively, the activity time indicated by the activity time and space range information of each acquisition object in the subset is within the preset time range, and the activity range indicated by the activity time and space range information of each acquisition object in the subset is within the preset space range.

In some embodiments, each of the at least one target clustered archive includes at least one activity event, each activity event including time and space range information. The operation module 130 is configured to: in response to that there are at least two target clustered archives, match time and space range information in activity events in the at least two target clustered archives to the target time and space range information, to determine a number of matching activity events in each of the at least two target clustered archives; and sequentially output the at least two target clustered archives in a descending order of the number of matching activity events

In some embodiments, the operation module 130 is configured to: in response to that there are at least two target clustered archives containing a same number of matching activity events, sequentially output, in a temporal order corresponding to time and space range information in activity events in the at least two target clustered archives containing the same number of matching activity events, the at least two target clustered archives containing the same number of matching activity events.

In some embodiments, the determination module 120 is further configured to: receive first selection information indicating a clustered archive library to be selected; receive second selection information indicating exclusion of a sub-library from the clustered archive library to be selected; and determine the clustered archive library according to the first selection information and the second selection information.

In some embodiments, the device further includes a generation module 140. The generation module 140 is configured to: acquire first image information of acquisition objects; determine, according to object features of the first image information, object feature classes of the acquisition objects contained in the first image information, each of the object feature classes corresponding to a respective acquisition object; generate, according to each of the object feature classes, a respective clustered archive; and form the clustered archive library according to clustered archives of the acquisition objects.

In some embodiments, the generation module 140 is further configured to: acquire identity information corresponding to second image information; determine, according to an object feature of the second image information, an object feature class matching the second image information; and generate, based on the identity information and the object feature class matching the second image information, a clustered archive corresponding to the object feature class matching the second image information.

In some embodiments, the operation module 130 is configured to: output, according to the at least one target clustered archive, archive information of an acquisition object in a temporal order.

In some embodiments, the operation module 130 is configured to: output, according to time and space range information contained in the at least one target clustered archive, an activity track of an acquisition object.

In some embodiments, the operation module 130 is further configured to: determine a start point and an end point of the activity track of the acquisition object; and display, on an electronic map, the start point and the end point of the activity track of the acquisition object.

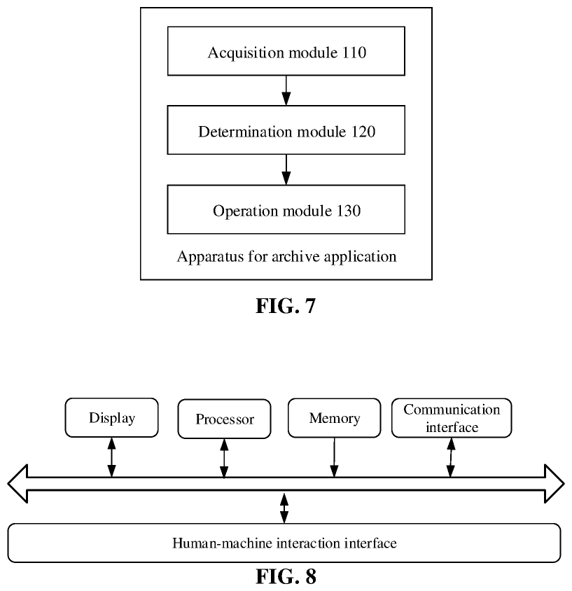

As illustrated in FIG. 8, in embodiments of the disclosure, also provided is a device for archive application, including: a memory configured to store information; and a processor connected respectively to a display and the memory. The processor is configured to implement, by executing computer-executable instructions stored in the memory, a method for archive application provided in one or more above-mentioned technical solutions, such as at least one of the methods for archive application as illustrated in FIG. 1 to FIG. 4.

The memory may be various types of memory, such as Random Access Memory (RAM), Read-Only Memory (ROM), flash memory, etc. The memory may be used for storing information, such as computer-executable instructions. The computer-executable instructions may be various program instructions, such as target program instructions and/or source program instructions.

The processor may be various types of processors, such as a central processing unit, a microprocessor, a digital signal processor, a programmable array, a digital signal processor, an application-specific integrated circuit, or an image processor. The processor may be connected to the memory through a bus. The bus may be an integrated circuit bus, etc.

In some embodiments, the terminal device may further include a communication interface. The communication interface may include a network interface (such as a local area network interface), a transceiver antenna, etc. The communication interface may also be connected to the processor and may be configured for information transceiving.

In some embodiments, the terminal device may further include a human-machine interaction interface. For example, the human-machine interaction interface may include various input/output devices such as a keyboard, or a touch screen.

In some embodiments, the device for archive application may further include a display. The display may display various prompts, acquired face images and/or various interfaces.

In embodiments of the disclosure, further provided is a computer storage medium having stored thereon a computer executable code that, when executed, can implement a method for archive application provided in one or more abovementioned technical solutions, such as at least one of the methods for archive application as illustrated in FIG. 1 to FIG. 4.

It is to be noted that, the device and method disclosed in embodiments of the disclosure may be implemented in other ways. The described device embodiments are merely exemplary. For example, the division of units is merely division in logical functions and may be realized in other ways in actual implementation. For example, multiple units or components may be combined, or integrated into another system, or some features/feature may be omitted or skipped. Furthermore, the coupling, or direct coupling or communicative connection among the components illustrated or discussed herein may be implemented through indirect coupling or communicative connection among some interfaces, devices, or units, and may be electrical, mechanical, or in other forms.

The units described as separate components may or may not be physically separate. Components illustrated as units may be or may not be physical units; they may be located in one place, or distributed on multiple network units. Some or all of the units may be selected to achieve the purpose of a solution of the embodiments as needed.

In addition, various functional units in each embodiment herein may be integrated into one processing module, or exist as separate units respectively; or two or more such units may be integrated in one unit. The integrated unit may be implemented in form of hardware, or in form of hardware plus software functional unit(s). A person skilled in the art may understand that all or part of the steps of the embodiments may be implemented by instructing a related hardware through a program, which program may be stored in a computer-readable storage medium and when executed, perform steps included in the above method embodiments. The storage medium may be various media that may store program codes, such as a mobile storage device, a Read-Only Memory (ROM), a Random Access Memory (RAM), a magnetic disk, a compact disk (CD), etc.

Methods disclosed in several method embodiments herein may be combined arbitrarily to form a new method embodiment without conflict.

Features disclosed in several device embodiments herein may be combined arbitrarily to form a new device embodiment without conflict.

Features disclosed in several method or device embodiments herein may be combined arbitrarily to form a new method embodiment or device embodiment without conflict.

Above are merely detailed description of the disclosure, which are not intended to limit the scope of protection of the disclosure. Any modification, equivalent replacement, and/or the like made within the technical scope herein, as may occur to a person of ordinary skill in the art, shall fall within the scope of the disclosure. The scope of protection of the disclosure should be subjected to the appended claims.

1. A method for archive application, comprising:
acquiring target time and space range information;
determining, based on the target time and space range information, at least one target clustered archive in a clustered archive library, wherein the at least one target clustered archive matches the target time and space range information, each of the at least one target clustered archive comprises archive information of a respective acquisition object, and the archive information comprises activity time and space range information of the respective acquisition object; and
performing a predetermined operation based on the at least one target clustered archive.

2. The method of claim 1, wherein the archive information comprises identity information of the respective acquisition object, and performing the predetermined operation based on the at least one target clustered archive comprises:
outputting, based on the at least one target clustered archive, identity information of an acquisition object in the at least one target clustered archive.

3. The method of claim 2, wherein performing the predetermined operation based on the at least one target clustered archive comprises:
outputting, based on first identity information in the at least one target clustered archive, archive information of a target clustered archive that matches preset second identity information.

4. The method of claim 1, wherein performing the predetermined operation based on the at least one target clustered archive comprises:
outputting, based on the at least one target clustered archive, a part of archive information of a subset of the at least one target clustered archive,
wherein activity time indicated by activity time and space range information of each acquisition object in the subset is within a preset time range; or an activity range indicated by the activity time and space range information of each acquisition object in the subset is within a preset space range; or
the activity time indicated by the activity time and space range information of each acquisition object in the subset is within the preset time range, and the activity range indicated by the activity time and space range information of each acquisition object in the subset is within the preset space range.

5. The method of claim 1, wherein each of the at least one target clustered archive comprises at least one activity event, each activity event comprising time and space range information, and performing the predetermined operation based on the at least one target clustered archive comprises:
in response to that there are at least two target clustered archives, matching time and space range information in activity events in the at least two target clustered archives to the target time and space range information, to determine a number of matching activity events in each of the at least two target clustered archives; and
sequentially outputting the at least two target clustered archives in a descending order of the number of matching activity events.

6. The method of claim 5, wherein performing the predetermined operation based on the at least one target clustered archive comprises:
in response to that there are at least two target clustered archives containing a same number of matching activity events, sequentially outputting, in a temporal order corresponding to time and space range information in activity events in the at least two target clustered archives containing the same number of matching activity events, the at least two target clustered archives containing the same number of matching activity events.

7. The method of claim 1, further comprising:
receiving first selection information indicating a clustered archive library to be selected;
receiving second selection information indicating exclusion of a sub-library from the clustered archive library to be selected; and
determining the clustered archive library according to the first selection information and the second selection information.

8. The method of claim 1, further comprising:
acquiring first image information of acquisition objects;
determining, according to object features of the first image information, object feature classes of the acquisition objects contained in the first image information, wherein each of the object feature classes corresponds to a respective acquisition object;
generating, according to each of the object feature classes, a respective clustered archive; and
forming the clustered archive library according to clustered archives of the acquisition objects.

9. The method of claim 8, further comprising:
acquiring identity information corresponding to second image information;
determining, according to an object feature of the second image information, an object feature class matching the second image information; and
generating, based on the identity information and the object feature class matching the second image information, a clustered archive corresponding to the object feature class matching the second image information.

10. The method of claim 1, wherein performing the predetermined operation based on the at least one target clustered archive comprises:
outputting, according to the at least one target clustered archive, archive information of an acquisition object in a temporal order.

11. The method of claim 1, wherein performing the predetermined operation based on the at least one target clustered archive comprises:
outputting, according to time and space range information contained in the at least one target clustered archive, an activity track of an acquisition object.

12. The method of claim 11, further comprising:
determining a start point and an end point of the activity track of the acquisition object; and
displaying, on an electronic map, the start point and the end point of the activity track of the acquisition object.

13. A device for archive application, comprising:
a memory configured to store computer-executable instructions; and
a processor connected to the memory and configured to execute the computer-executable instructions to:
acquire target time and space range information;
determine, based on the target time and space range information, at least one target clustered archive in a clustered archive library, wherein the at least one target clustered archive matches the target time and space range information, each of the at least one target clustered archive comprises archive information of a respective acquisition object, and the archive information comprises activity time and space range information of the respective acquisition object; and
perform a predetermined operation based on the at least one target clustered archive.

14. The device of claim 13, wherein the archive information comprises identity information of the respective acquisition object, and in performing the predetermined operation based on the at least one target clustered archive, the processor is configured to execute the computer-executable instructions to:
output, based on the at least one target clustered archive, identity information of an acquisition object in the at least one target clustered archive.

15. The device of claim 13, wherein in performing the predetermined operation based on the at least one target clustered archive, the processor is configured to execute the computer-executable instructions to:
output, based on first identity information in the at least one target clustered archive, archive information of a target clustered archive that matches preset second identity information.

16. The device of claim 13, wherein in performing the predetermined operation based on the at least one target clustered archive, the processor is configured to execute the computer-executable instructions to:
output, based on the at least one target clustered archive, a part of archive information of a subset of the at least one target clustered archive,
wherein activity time indicated by activity time and space range information of each acquisition object in the subset is within a preset time range; or an activity range indicated by the activity time and space range information of each acquisition object in the subset is within a preset space range; or
the activity time indicated by the activity time and space range information of each acquisition object in the subset is within the preset time range, and the activity range indicated by the activity time and space range information of each acquisition object in the subset is within the preset space range.

17. The device of claim 13, wherein each of the at least one target clustered archive comprises at least one activity event, each activity event comprising time and space range information and in performing the predetermined operation based on the at least one target clustered archive, the processor is configured to execute the computer-executable instructions to:
in response to that there are at least two target clustered archives, match time and space range information in activity events in the at least two target clustered archives to the target time and space range information, to determine a number of matching activity events in each of the at least two target clustered archives; and
sequentially output the at least two target clustered archives in a descending order of the number of matching activity events.

18. The device of claim 14, wherein in performing the predetermined operation based on the at least one target clustered archive, the processor is configured to execute the computer-executable instructions to:
in response to that there are at least two target clustered archives containing a same number of matching activity events, sequentially output, in a temporal order corresponding to time and space range information in activity events in the at least two target clustered archives containing the same number of matching activity events, the at least two target clustered archives containing the same number of matching activity events.

19. The device of claim 13, wherein the processor is further configured to execute the computer-executable instructions to:
receive first selection information indicating a clustered archive library to be selected;
receive second selection information indicating exclusion of a sub-library from the clustered archive library to be selected; and
determine the clustered archive library according to the first selection information and the second selection information.

20. A non-transitory computer-readable storage medium having stored thereon computer-executable instructions that, when executed by a processor, implement following:
acquiring target time and space range information;
determining, based on the target time and space range information, at least one target clustered archive in a clustered archive library, wherein the at least one target clustered archive matches the target time and space range information, each of the at least one target clustered archive comprises archive information of a respective acquisition object, and the archive information comprises activity time and space range information of the respective acquisition object; and
performing a predetermined operation based on the at least one target clustered archive.
